(19) United States
(12) Patent Application Publication
(10) Pub. No.: US 2015/0132174 A1
(43) Pub. Date: May 14, 2015

(54) Rare Earth Composite Magnets with Increased Resistivity

(71) Applicant: Electron Energy Corporation, Landisville, PA (US)

(72) Inventors: Melania Marinescu, Reinholds, PA (US); Jinfang Liu, Lancaster, PA (US); Alksandr Gabay, Newark, DE (US); George C. Hadjipanyis, Centerville, DE (US)

(21) Appl. No.: 14/318,749

(22) Filed: Jun. 30, 2014

Related U.S. Application Data
(63) Continuation of application No. 12/554,594, filed on Sep. 4, 2009, now abandoned.

(51) Int. Cl. H01F 1/057; H01F 41/02; H01F 1/055

(52) U.S. Cl. CPC H01F 1/0577; H01F 1/0556; H01F 1/0557; H01F 1/0576; H01F 41/0266
USPC 419/19; 419/10; 75/230; 75/233

(57) ABSTRACT

Dielectric rare earth fluorides are blended with rare earth magnet powders to produce high-resistivity fluoride composite rare earth magnets.

### CROSS-REFERENCE TO RELATED APPLICATIONS

This application is a continuation of commonly owned U.S. application Ser. No. 12/554,594, filed 4 Sep. 2009, the disclosure of which is hereby incorporated herein by reference.

### STATEMENT OF GOVERNMENT SUPPORT

This invention was made with government support under Grant No. DE-FG02-07ER86308 awarded by the Department of Energy. The United States government has certain rights in the invention.

### BACKGROUND OF THE INVENTION

The present invention relates to rare earth permanent magnets for use in rotary equipment, motors and generators. Addressing eddy current losses represents one of the important factors in the design of motors and high speed generators. Reduction of these eddy current losses in permanent magnets used with rotary equipment is best achieved by increasing their electrical resistivity. When the magnets are subjected to variable magnetic flux , if the electrical resistivity is low, a large amount of heat due to eddy current is generated, which in turn reduces their magnetic properties and therefore the efficiency of rotary equipment. High resistivity is achieved by using various insulating means to increase the electrical resistivity of rare earth magnets.

U.S. Pat. No. 5,858,124 teaches the addition of various fluorides and oxides of Li, Na, Mg, Ca, Ba and Sr to Sm—Co and Nd—Fe—B rare earth permanent magnets to increase electrical resistivity, along with improved magnetic properties; whereas, U.S. Pat. No. 7,153,591 teaches the addition of rare earth fluorides (RF₃) to R—Fe—B permanent magnet powders to provide bonded magnets having high intrinsic coercivity (H_{ci}).

To date, attempts to increase resistivity as described in the prior art have generally sacrificed rare earth permanent magnet performance and/or fallen short in increasing electrical resistivity.

Accordingly, improvements in rare earth magnet resistivity are sought as detailed in the objects of the invention as set out below.

### OBJECTS OF THE INVENTION

An object of the invention is to increase electrical resistivity of permanent magnets in order to reduce eddy current loss for motors and generators.

A further object of the invention is to develop new composite magnets with high resistivity and superior magnetic properties to reduce eddy current loss.

Yet another object of the invention is to improve the electrical resistivity and performance of rare earth permanent magnets.

Still another object of the invention is to improve the electrical resistivity of rare earth permanent magnets while reducing the manufacturing cost for these composite, permanent magnets used in rotary equipment including motors and generators.

### BRIEF DESCRIPTION OF THE DRAWINGS

The above and other objects, features and other advantages of the present invention will be better understood from the following detailed description taken in conjunction with the accompanying drawing, in which:

FIG. 1 illustrates the demagnetization curves for die-upset magnets made of blended Pr_{14.5}Fe_{79.5}B₆ and CaF₂/NdF₃/DyF₃ powders. The fluoride additions increase the electrical resistivity of the magnets at least two times.

FIG. 2 shows the schematic morphology of the hot-pressed and die-upset RE—Fe—B magnets.

FIG. 3 illustrates the SEM image for a Nd_{14.5}Fe_{79.5}B₆/5 wt. % DyF₃ hot-pressed magnet.

FIG. 4 illustrates the SEM image (left) for a hot pressed and die upset Pr_{14.5}Fe_{79.5}B₆/5 wt. % DyF₃ magnet and EDX line scans (right) showing the distribution of the elements in the vicinity of the grain boundaries.

FIG. 5 shows the backscattered electron SEM image and concentration line scan for Pr_{14.5}Fe_{79.5}B₆/5 wt % of CaF₂ die-upset magnet. The starting point of the line scan is marked with 1. Arrows indicate the pressure direction.

FIG. 6 shows the backscattered electron SEM image for Pr_{14.5}Fe_{79.5}B₆/5 wt % of CaF₂ die-upset magnet and the corresponding element concentration maps for Pr, Fe, Ca, and F. Arrows indicate the pressure direction.

FIG. 7 shows the demagnetization curves of magnets synthesized from Sm(Co_{0.70}Fe_{0.21}Cu_{0.06}Zr_{0.03})_{7.4} with different percentage of added Sm-rich Sm(Co_{0.66}Fe_{0.24}Cu_{0.07}Zr_{0.03})_{4.9} and CaF₂ powders.

FIG. 8 illustrates the magnetic properties of optimized fully dense Sm(Co_{0.66}Fe_{0.27}Cu_{0.05}Zr_{0.02})_{7.7}+16 wt % Sm(Co_{0.62}Fe_{0.30}Cu_{0.06}Zr_{0.02})_{4.9}/CaF₂ composite magnet with the resistivity increased 30% compared to the commercial Sm—Co 2:17 magnets. These magnets are able to operate at temperatures of 240° C. and above.

FIG. 9 shows (a) backscattered electron SEM micrograph and (b) EDX map for oxygen showing dielectric boron oxide and few samarium oxide inclusions within the Sm(Co, Fe, Cu, Zr)_{z}/B₂O₃ (2.5 wt %) “glass-bonded” magnet.

### SUMMARY OF THE INVENTION

The present invention reduces the eddy currents in permanent magnets by introducing homogeneously distributed dielectric material inside the body of magnets. Especially in RE—Fe—B magnets, a morphology similar to laminated steel is formed. The preferred dielectric substances are rare earth calcium oxides, rare earth calcium fluorides, or rare earth boron oxides that are blended with rare earth magnet powders and consolidated with methods such as sintering, hot pressing and die upsetting to achieve full density, high resistivity composite magnets.

In distinguishing from the prior art, the present invention is directed to increasing the resistivity of rare earth magnets (RE magnets), including Sm—Co and RE—Fe—B magnets (RE represents Rare Earth elements, especially Pr, Nd, Dy, and Tb). This increased resistivity is attained while improving coercivity of such fully dense composite magnets with only a small reduction in residual induction by the addition of resistivity enhancing agents. The resistivity enhancing agents of the invention are selected from a group of fluorides and oxyfluorides consisting of Ca(F,O)ₓ; (RE,Ca)(F,O)ₓ; REFₓ, RE(F,O)ₓ and mixtures thereof, where RE is selected from the group consisting of rare earth elements and mixtures thereof, and B₂O₃

The addition of resistivity enhancing agents of the invention to Pr—Fe—B magnets prepared by hot pressing and die upsetting not only results in an electrical resistivity substantially greater than conventional Pr—Fe—B magnets, but also results in increased intrinsic coercivity, H_{ci}, of these RE magnets.

Die-upset rare earth composite magnets of the invention comprised of blends of Pr_{14.5}Fe_{79.5}B₆ with: NdF₃ or DyF₃ powders are obtained using the grain boundary diffusion process. The resulting Pr—Fe—B/fluoride composites indicate an electrical resistivity substantially greater than conventional Pr—Fe—B magnets; while maintaining good magnetic performance. The addition of NdF₃ to Pr—Fe—B magnets of the invention results in an improvement in the squareness of the demagnetization curves, as shown in the drawings.

Of particular interest are RE—Fe—B/DyF₃ composites produced by die upsetting, in which case Dy appears to exchange places with RE in the RE-rich phase existing in over-stoichiometric 2:14:1 composition. A longer time exposure at high temperatures results in Dy penetration along the boundaries of 2:14:1 grains, thus increasing the local magnetic anisotropy and the intrinsic coercivity .

The addition of CaF₂ to Sm—Co magnets prepared by sintering results in an increase of up to about 150% in electrical resistivity without significant degradation of magnetic properties. The addition of B₂O₃ to Sm—Co magnets prepared by hot pressing results in an increase of about 10 times in electrical resistivity while the magnetic performance still allows for the practical use of these magnets.

One embodiment of the present invention is a high electrical resistivity rare earth magnet, RE—Fe—B comprising a blend of RE_{11.7+x}TM_{88.3-x-y}B_{y}, where RE is selected from the group consisting of rare earth elements Nd, Pr, Dy, and Tb, and TM is selected from the group consisting of transition metal elements, Fe, Co, Cu, Ga, and Al, with powder selected from the group of fluorides and oxyfluorides consisting of Ca(F,O)ₓ; (RE,Ca)Fₓ; (RE,Ca)(F,O)ₓ; REFₓ, RE(F,O)ₓ and mixtures thereof; where RE is selected from the group consisting of rare earth elements and mixtures thereof, and said composite rare earth magnet has an intrinsic coercivity H_{ci} at least comparable to conventional RE—Fe—B magnets, where x is 0 to 5, and y is 5 to 7.

Another embodiment of the present invention is a fully dense composite magnet made of blends of Sm(Co,Fe,Cu,Zr)_{z} powders and powders selected from the group consisting of fluorides and oxyfluorides having improved electrical resistivity of at least 50% higher than conventional Sm(CoFe,Cu,Zr)_{z} magnets; where the powdered fluorides and oxyfluorides are selected from the group consisting of Ca(F,O)ₓ; (RE,Ca)Fₓ; (RE,Ca)(F,O)ₓ; REFₓ, RE(F,O)ₓ and mixtures thereof, where RE is selected from the group consisting of rare earth elements and mixtures thereof, where z is 6 to 8.5 and x is 0 to 5.

Yet another embodiment of the present invention is a method for increasing the electrical resistivity and intrinsic coercivity of rare earth magnets, comprising sintering and hot pressing precursor blends of RE_{11.7+x}TM_{88.3-x-y}B_{y}, where RE is selected from the group consisting of rare earth elements, Nd, Pr, Dy, and Tb, and TM is selected from the group consisting of transition metal elements Fe, Co, Cu, Ga, and Al, with powders selected from the group of fluorides and oxyfluorides consisting of Ca(F,O)ₓ; (RE,Ca)Fₓ; (RE,Ca)(F,O)ₓ; REFₓ, RE(F,O)ₓ and mixtures thereof, where x is 0 to 5 and y is 5 to 7.

Another embodiment of the present invention is a method for improving the electrical resistivity of rare earth magnets comprising hot pressing and die upsetting blends of RE_{11.7+x}TM_{88.3-x-y}B_{y} powders/ribbons prepared by mechanical alloying and melt-spinning, where RE is selected from the group consisting of rare earth elements, Nd, Pr, Dy, and Tb, and TM is selected from the group consisting of transition metal elements, Fe, Co, Cu, Ga, and Al, and powders selected from the group of fluorides and oxyfluorides consisting of Ca(F,O)ₓ; (RE,Ca)Fₓ; (RE,Ca)(F,O)ₓ; REFₓ, RE(F,O)ₓ, B₂O₃ and mixtures thereof; where RE is selected from the group consisting of rare earth element and mixtures thereof, where the magnets comprise layered morphology, where x is 0 to 5 and y is 5 to 7.

Yet another embodiment of the present invention is a method for increasing the electrical resistivity of rare earth magnets, comprising sintering and heat treating precursor blends of powdered Sm(CoᵤFeᵥCu_{w}Zrₕ)_{z} where u is 0.5 to 0.8, v is 0.1 to 0.35, w is 0.03 to 0.10, h is 0.01 to 0.05, z is 6 to 8.5, and powders selected from the group of fluorides and/or oxyfluorides consisting of Ca(F,O)ₓ; (RE,Ca)Fₓ; (RE,Ca)(F,O)ₓ; REFₓ, RE(F,O)ₓ and mixtures thereof; RE is selected from the group consisting of rare earth elements and mixtures thereof, and where x is 0 to 5.

Another embodiment of the present invention is a method for increasing the electrical resistivity of rare earth magnets, comprising hot-pressing precursor blends of B₂O₃ powder and Sm(CoᵤFeᵥCu_{w}Zrₕ)_{z} powders where u is 0.5 to 0.8, v is 0.1 to 0.35, w is 0.03 to 0.10, h is 0.01 to 0.05, z is 6 to 8.5, or RE_{11.7+x}TM_{88.3-x-y}B_{y} powders/ribbons, where x is 0 to 5, y is 5 to 7, and RE is selected from the group consisting of rare earth elements Nd, Pr, Dy, and Tb and TM is selected from the group consisting of transition metal elements Fe, Co, Cu, Ga, and Al.

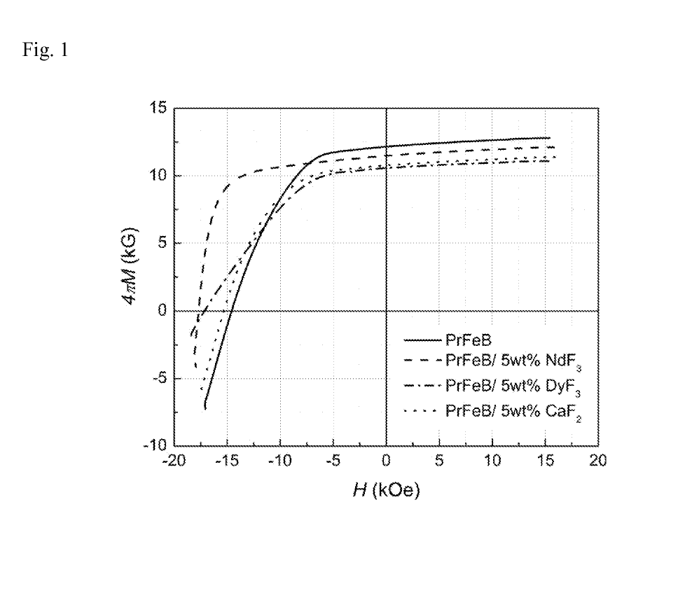

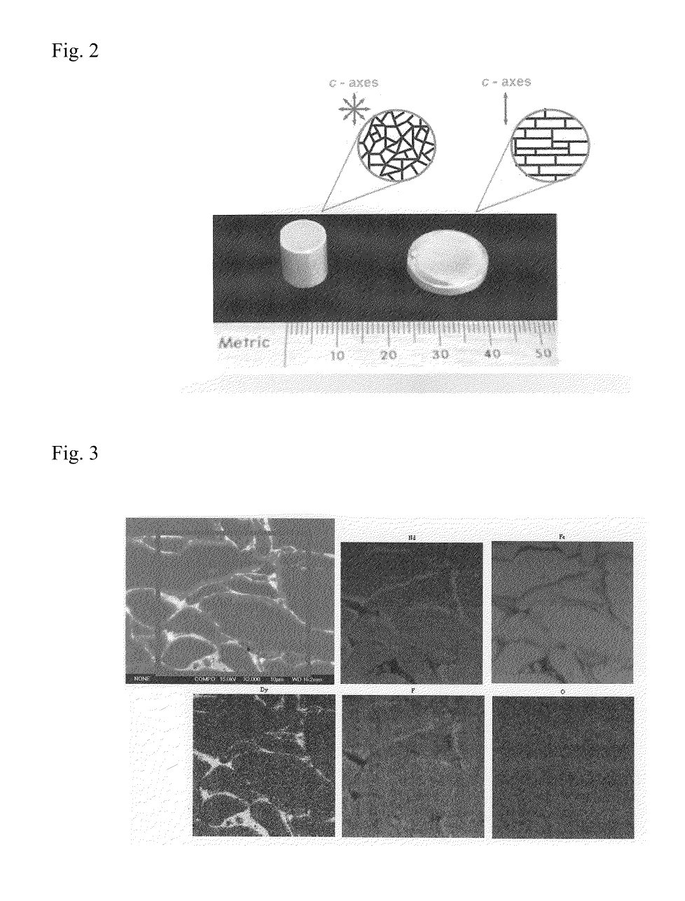

One preferred embodiment of the present invention is the high-resistivity fluoride composite rare earth permanent magnet, Pr_{14.5}Fe_{79.5}B₆/5% wt % CaF₃/NdF₃/DyF₃ having the magnetic properties shown in FIG. 1.

Another preferred embodiment of the present invention is the high-resistivity fluoride, hot pressed rare earth magnet, Nd_{14.5}Fe_{79.5}B₆/5 wt % DyF₃ having the SEM image shown in FIG. 3.

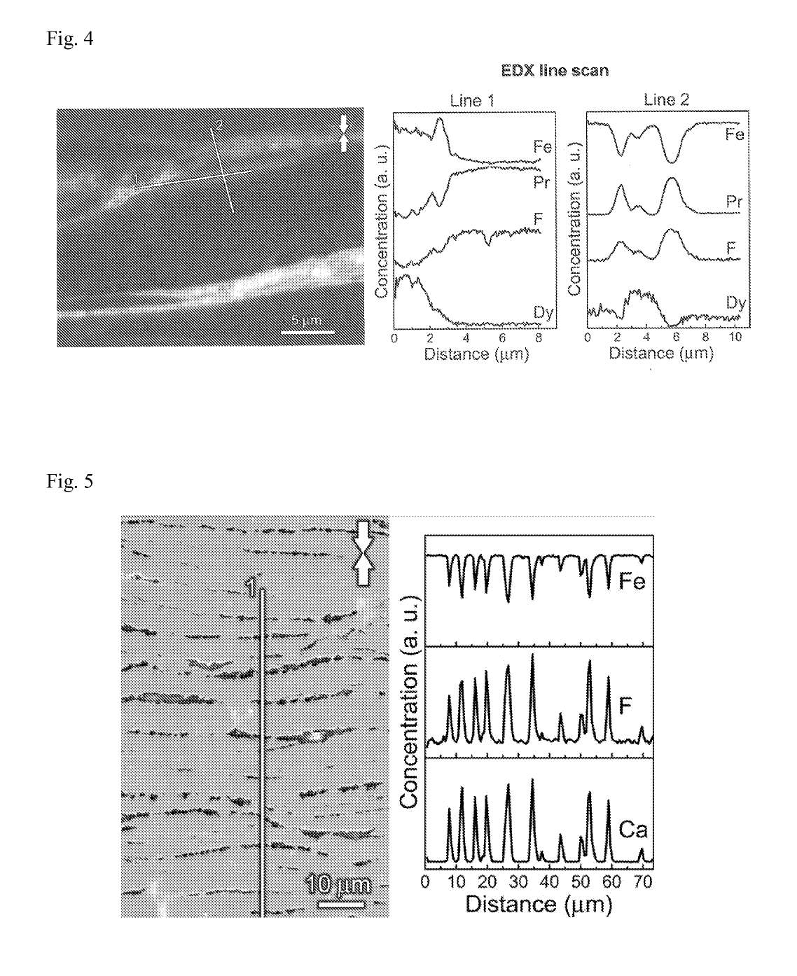

Another preferred embodiment of the present invention is the high-resistivity fluoride added, die-upset, rare earth magnet, Pr_{14.5}Fe_{79.5}B₆/5 wt % DyF₃ having the elemental distribution in the vicinity of the layer boundaries shown in FIG. 4.

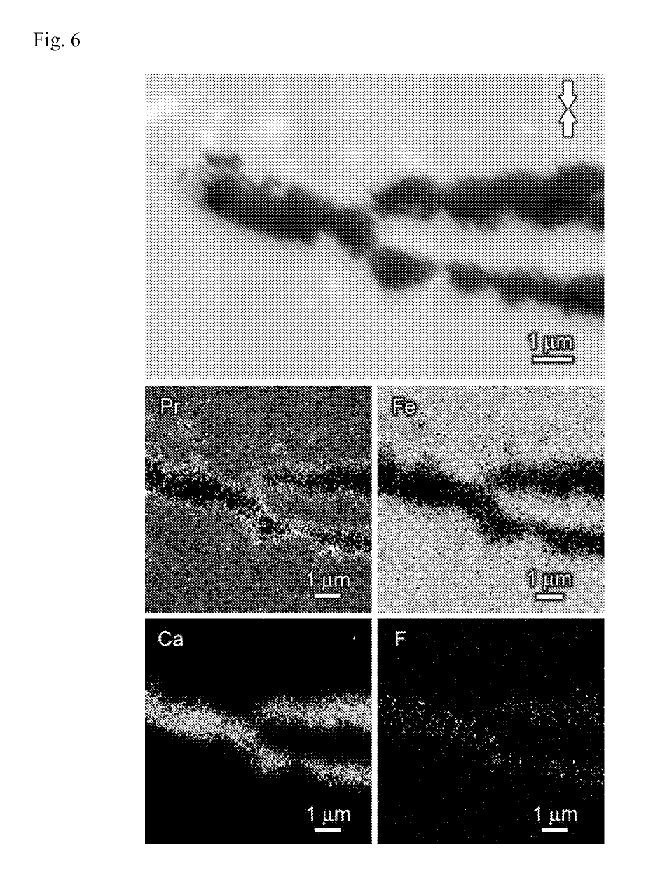

Yet another preferred embodiment of the present invention is the high-resistivity fluoride added, die-upset, rare earth magnet, Pr_{14.5}Fe_{79.5}B₆/5 wt % CaF₃ having the elemental distribution across the layer boundaries shown in FIG. 5 and the elemental distribution in the vicinity of the Pr-rich phase shown in FIG. 6.

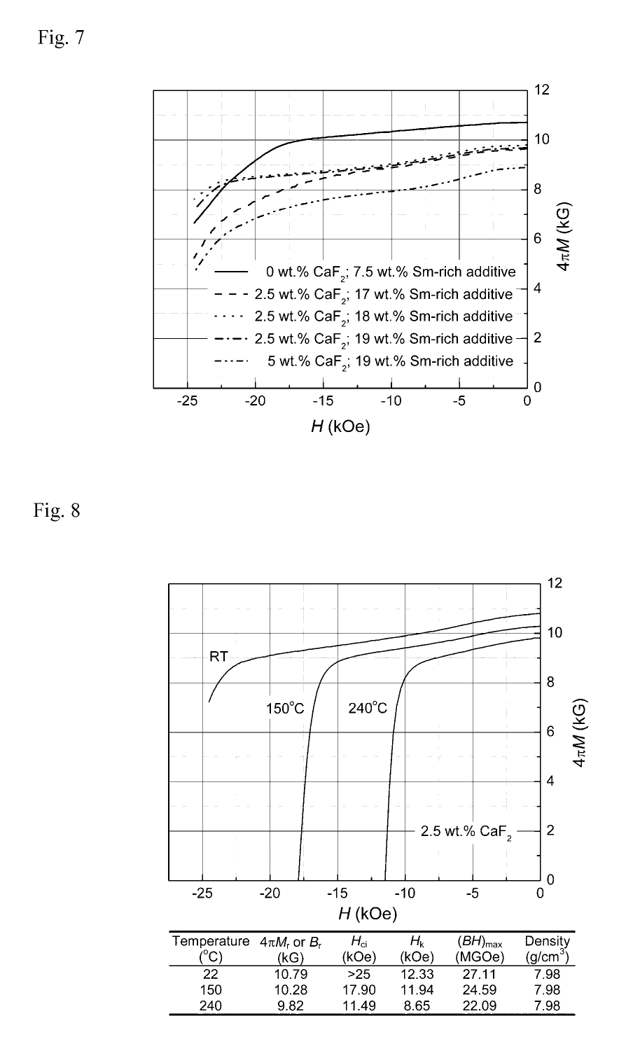

Yet another preferred embodiment of the present invention is the high-resistivity fluoride added, sintered Sm(Co,Fe,Cu,Zr)_{z}/CaF₃ having the demagnetization curves shown in FIG. 7.

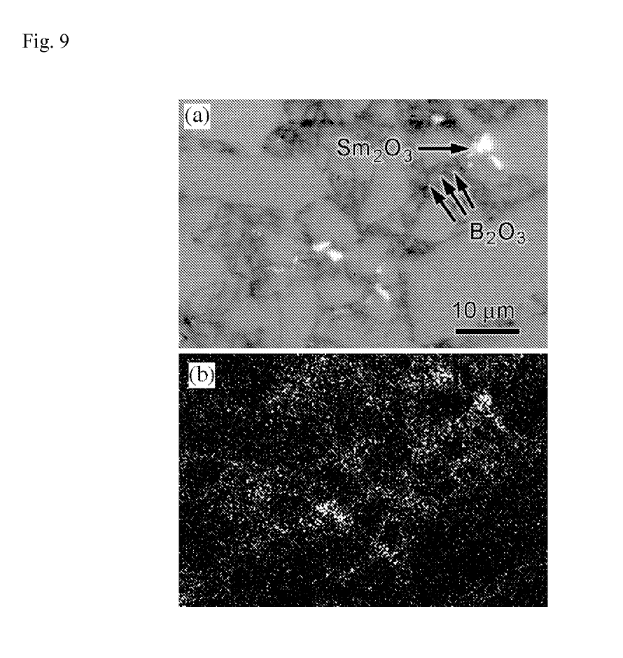

Yet another preferred embodiment of the present invention is the high-resistivity fluoride added, sintered Sm(Co,Fe,Cu,Zr)_{z}/CaF₃ having the magnetic properties at different temperatures shown in FIG. 8.

Yet another preferred embodiment of the present invention is the high-resistivity B₂O₃ added, hot-pressed Sm(Co,Fe,Cu,Zr)_{z}/B₂O₃ having microstructure and the distribution of B₂O₃ shown in FIG. 9.

### DETAILED DESCRIPTION OF THE INVENTION

As described above, the present invention is directed to reducing eddy current losses in permanent magnet for electrical machines by increasing the electrical resistivity in new composite magnets which contain dielectric constituents.

Specifically, the present invention is directed to the discovery that dielectric (oxy)fluorides and boron oxides can be blended into R—Co and R—Fe—B rare earth magnets with minimal effect on the magnetic and mechanical properties of R—Co and R—Fe—B magnets.

It has been observed that good electrical isolation with minimum adverse effect to the magnetization is obtained with the present invention where the dielectric substance forms very thin layers along the grain boundaries. Ideally, such thin layers are continuous.

Three mechanisms of action are suggested to optimize morphology at the grain boundaries of the fluoride composite magnets of the invention:
1. melting the dielectric phase resulting in wetting the matrix material,
2. substantially uniform distribution of nanoparticles of the dielectric substance along grain boundaries, and
3. substantially uniform distribution of very thin solid dielectric flakes along grain boundaries.

When blending Sm—Co permanent magnet powder with B₂O₃, the dielectric distribution substantially uniformly around the magnet powder particle is attributed in part to the fact that the dielectric was hot pressed in the molten state. Such morphology is particularly beneficial for increasing resistivity.

Fully dense rare earth permanent magnets used in dynamic applications such as traction motors are electrically conductive, which leads to reduced efficiency due to eddy current losses.

In the case of permanent magnet rotors where the torque is produced by a complex interaction of a space harmonic magnetomotive force superposed with a time harmonic of the phase currents, the eddy current losses, Wₘ, remain inversely proportional to the resistivity P, as described by the equation:

$${W}_{m} = \frac{1}{ρ} \cdot [ \frac{{p}_{r} {ω}_{r}}{π} {\int }_{0}^{\frac{2 π}{{ω}_{r}}} {\int }_{{R}_{r}}^{{R}_{m}} {\int }_{- \frac{{α}_{p}}{2}} {( \frac{\partial A ( r , θ , t )}{\partial t} + C ( t ) )}^{2} r d r d θ d t ]$$

where θ=angular coordinate, r=radial coordinate, t=time, C=integration const., A=vector magnetic potential.

Thus, variation of resistivity can control the eddy current losses through a simple inverse proportionality. For example, by increasing the resistivity 10 times, eddy current losses will decrease by 90%.

The high electrical resistivity magnets according to the present invention is preferably an RE—Fe—B-based magnet or an RE—Co-based magnet, where each R is at least one rare earth element including Y (yttrium).

The RE—Fe—B-based magnet comprises 10-40 weight % of RE (rare earth element), 0.5-5 weight % of B (boron) and a balance of Fe and other transition metal elements. Nd, Pr and Dy are preferred elements for the RE, and Nd is particularly preferable. Further, it is preferred to use Dy up to 50 weight %, preferably up to 30 weight % of the total amount of R in view of improving the coercive force and reducing the production cost.

The RE—(Fe,M)—B-based magnet may contain optional elements M, such as Co, Nb, Al, Ga and Cu. Co is added to improve the corrosion resistivity and heat stability, and may be added up to 25 weight % based on the total amount of the RE—Fe—B-based magnet. An additional amount exceeding 25 weight % unfavorably reduces the residual magnetic flux density and intrinsic coercive force. Nb is effective for preventing the overgrowth of grain size and enhancing the coercive force and heat stability. Since an excess amount of Nb reduces the residual magnetic flux density, Nb is preferred to be added up to 5 weight % based on the total amount of the R—Fe—B-based magnet. Although other element, M, is effective for enhancing the coercive force, an excess amount of M reduces the residual magnetic flux density. Therefore, M is added in amount of 0.01-2 weight % in total based on the total amount of the R—Fe—B-based magnet.

The RE—Co-based magnet, also known as RE(Co,Fe,Cu, M′)_{z} magnets (z=5-9), comprises 10-35 weight % of RE, 30 weight % or less of Fe, 1-10 weight % of Cu, 0.1-5 weight % of M′ (M′ represents at least one of Ti, Zr and Hf), and a balance of Co, each weight percentage being based on the total amount of the RE—Co-based magnet. The RE—Co-based magnet is preferred to have Zn₂Th₁₇ type crystal structure.

In the RE—Co-based magnet, the rare earth element RE, together with Co, forms the Zn₂Th₁₇ type crystal structure which is responsible for the magnetism, and R is preferred to consist of Sm and at least one of Ce, Pr, Tb, Er, Ho and Gd. When the amount of RE is lower than 10 weight %, the coercive force and the squareness ratio are low, and the residual magnetic flux density is reduced when RE exceeds 35 weight %. Although a high Br can be achieved by the addition of Fe, a sufficient coercive force cannot be obtained when the amount exceeds 30 weight %. It is preferable to add Fe at least 5 weight % in view of improving Br. Cu contributes to improving the coercive force. However, the addition of less than 1 weight % of Cu shows no improving effect, and the residual magnetic flux density and coercive force are reduced when the addition exceeds 10 weight %. M′ promotes the generation of TbCu₇ type crystalline structure corresponding to (RE, Zr)(Fe, Co, Cu)₇ after solution treatment, however, an excess amount of M′ reduces the residual magnetic flux density.

The R—Fe—B-based magnet and R—Co-based magnets used in the present invention may include inevitable impurities such as C, N, O, Al, Si, etc., in an amount usually contained in such magnets.

The rare earth magnet of high electrical resistivity according to the present invention may be produced by mechanically mixing the powder of rare earth magnet and at least one of the resistivity-increasing agents, compacting the mixture, and heat-sintering the compacted mixture. The rare earth magnet of high electrical resistivity may also be produced by spark plasma sintering of the powder mixture. Further, the powder mixture may be densified by hot press, HIP, extrusion or upsetting work to obtain rare earth magnets of high electrical resistivity.

The RE—Fe—B-based magnet powder may be prepared by coarsely pulverizing an RE—Fe—B ingot produced by melting and casting the starting material, and then finely pulverizing in a jet mill, ball mill, etc., to particles having an average size of 1-10 μm, preferably 3-6 μm. The RE—Fe—B-based magnet powder and at least one resistivity-increasing agent are mechanically mixed with each other. The powder mixture is compacted under a pressure of 500-3000 kgf/cm² in a magnetic field of 1-20 kOe to obtain a green body, which is then sintered at 1000°-1150° C. for 1-6 hours in vacuum or in an inert gas atmosphere such as Ar atmosphere. The sintered product may be further heat-treated at 450°-900° C. for 1-6 hours to obtain a rare earth magnet of high electrical resistivity.

The RE—Fe—B-based magnet powder for spark plasma sintering, hot press and HIP may be magnetically isotropic or anisotropic powder having an average particle size of 1-500 μm. The magnetically isotropic powder may be produced by a fast quenching method, and has a structure comprising RE₂Fe₁₄B phase and RE-rich phase; α-Fe phase and RE₂Fe₁₄B phase; or Fe₂B phase and RE₂Fe₁₄B phase. The RE—Fe—B-based magnet powder having any of these metal structures may be usable. The magnetically anisotropic powder may be obtained by hydrogen decrepitation of an RE—Fe—B alloy and a subsequent dehydrogenation, or by heat-densifying a super-quenched RE—Fe—B alloy powder, upsetting the densified powder, and pulverizing the upset powder. The magnetically isotropic or anisotropic powder thus obtained is mechanically mixed with at least one resistivity-increasing compound. The powder mixture may be compacted to a green body, prior to being subjected to the spark plasma sintering, hot press or HIP, under a pressure of 300-6000 kgf/cm² in the absence of external magnetic filed for the isotropic powder or under the influence of an external magnetic field of 1-20 kOe for the anisotropic powder. The green body is subjected to a spark plasma sintering, hot press or HIP to obtain the rare earth magnet of high electrical resistivity according to the present invention with or without after-heat treatment at 400°-700° C. for 1-5 hours.

In the spark plasma sintering, a DC pulse current of 200-1000 A is passed through the green body at 20-80 V for 5-90 seconds in vacuum of 10⁻⁷ to 1 Torr while applying a compressive pressure of 100-500 kgf/cm² to generate spark plasma between the powder particles. After the generation of spark plasma, the green body is sintered at 600°-1000° C. for 100-1000 seconds under a pressure of 100-5000 kgf/cm², while allowing a DC current of 50-1000 A to pass through the green body. The spark plasma locally creates a high temperature region and activates the particle surface. Since the resistivity-increasing compound has a high electrical resistivity, the powder particles thereof are preferentially heated by Joule heat. This promotes the sintering and prevents the magnet powder from overgrowing to finely and uniformly disperse the magnet phase throughout the compound phase.

The hot pressing is conducted at 600°-1000° C. for 1-10 hours under a pressure of 500-6000 kgf/cm².

The HIP is conducted at 600°-1000° C. for 1-10 hours under a pressure of 500-2000 kgf/cm².

The RE—Fe—B-based magnet powder for die upsetting or extrusion may be obtained by super-quenching a molten RE—Fe—B alloy and pulverizing the resultant flake-shaped alloy to an average particle size of 0.05-1 mm. The magnet powder is then mechanically mixed with at least one resistivity-increasing compound, and compacted at 600°-1000° C. under 300-2000 kgf/cm² to form a green body, which is then subjected to die upsetting or extrusion at 600°-1000° C.

The R—Co-based magnet powder may be obtained by a melting method or a reductive diffusion method.

In the melting method, the alloying metals such as RE, Co, Fe, Cu, Ti, Zr and Hf are melted by a high-frequency melting or an arc melting and cooled to obtain an ingot. After subjected to a solution treatment at 1000°-1250° C. for 4-48 hours and a subsequent aging treatment at 600°-900° C. for 4-48 hours, if desired, the ingot is pulverized to obtain an RE—Co-based magnet powder having an average particle size of 4-500 μm. The RE—Co-based magnet powder thus obtained is mechanically mixed with at least one resistivity-increasing compound, and is compacted under a pressure of 500-8000 kgf/cm² in a magnetic filed of 1-20 kOe to obtain a green body, which is then subjected to the heat-sintering, spark plasma sintering, hot pressing or HIP in the same manner as described above and optionally subjected to a solution treatment at 1000°-1220° C. for 4-48 hours and an aging treatment at 650°-900° C. for 4-48 hours to obtain the rare earth magnet of high electrical resistivity according to the present invention.

The present invention will be further described while referring to the following Examples which should be considered to illustrate various preferred embodiments of the present invention.

### EXAMPLES

### Examples 1-6

Development of Fe₂F₁₄B/fluoride magnets with increased electrical resistivity, Nd_{14.5}Fe_{79.5}B₆, and Pr_{14.5}Fe_{79.5}B₆ anisotropic permanent magnets were synthesized by hot pressing and die upsetting. The precursor powders were produced with a nanocrystalline structure by melt spinning 5% by wt. of NdF₃ and DyF₃ were added to the magnets. The magnets were hot pressed at 650-700° C. and die-upsetted (hot plastic deformation) at 800° C. The following results were observed:

Almost fully dense composite (Pr, Nd)_{14.5}Fe_{79.5}B₆/NdF₃ or DyF₃ magnets produced by hot pressing and die upsetting show an electrical resistivity substantially higher than 2:14:1 magnets without fluoride, as summarized in Table 1. The great advantage of 2:14:1 phase in conjunction with rare earth fluorides is that upon hot pressing and die upsetting, the fluorides distribute in layers driven by a rare-earth rich phase which is in the molten state at the hot pressing and die upsetting temperature. Dy tends to concentrate at the very edge of the matrix boundary. This phenomenon proves to be favorable for intrinsic coercivity as detailed in FIG. 1.

TABLE 1
Electrical resistivity and density of composite 2:14:1/fluoride
magnets produced by hot pressing and die upsetting

| | | Density | Resistivity |
|---|---|---|---|
| Example | Composition | (g/cm³) | (μΩcm) |
| 1 | 100% (Pr, Nd)_{14.5}Fe_{79.5}B₆/5% | 7.49-7.54 | 125-135 |
| | NdF₃ | (ingot density) | |
| 2 | 95% Pr_{14.5}Fe_{79.5}B6/5% NdF₃ | 7.40 | 290-310 |
| 3 | 95% Nd_{14.5}Fe_{79.5}B₆/5% DyF₃ | 7.46 | 230-250 |
| 4 | 95% Pr_{14.5}Fe_{79.5}B₆/5% DyF₃ | 7.37 | 680-780 |

Various means for manipulating the diffusion of F to form insulating layers at the grain boundary is illustrated in FIGS. 3-6.

Fluoride composite Pr—Fe—B die-upset magnets with increased electrical resistivity are described, where (Pr, Nd)_{14.5}Fe_{79.5}B₆/5 wt. % NdF₃ or DyF₃ composite magnets prepared by hot pressing show an electrical resistivity at least twice as high as of the isotropic counterparts without the fluoride addition. The hot pressed specimens are subjected to hot deformation by die upsetting in order to develop a crystallographic and magnetic texture have a resistivity measured perpendicularly to the texture direction only slightly increased compared to the magnets without the fluoride addition. Fluorides (e.g., NdF₃) can be effective for improving the squareness of the demagnetization curve.

As described above, the rare earth composite magnets of the present invention with at least one of the resistivity enhancing agents of the invention has an increased electrical resistivity, as well as high magnetic properties such as residual flux density and high intrinsic coercivity. The high-resistivity rare earth composite magnets of the present invention therefore exhibit high energy efficiency when used in rotary equipment such as motors and generators.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The optimum amount of Sm-rich Sm(Co_{0.66}Fe_{0.24}Cu_{0.07}Zr_{0.03})_{4.9} powder needed to be added to base Sm(Co_{0.70}Fe_{0.21}Cu_{0.06}Zr_{0.03})_{7.4} powder in order to achieve the best hard magnetic performance in the sintered magnets is about 7.5 wt %. In order to preserve a high H_{ci} of 25 kOe after adding 2.5-5.0 wt. % CaF₂, the amount of the Sm-rich powder had to be increased up to 19 wt. %, as it is shown in FIG. 7. The Sm—Co composition optimized by mixing Sm(Co_{0.66}Fe_{0.27}Cu_{0.05}Zr_{0.02})_{7.7} and 16 wt % of Sm(Co_{0.62}Fe_{0.30}Cu_{0.06}Zr_{0.02})_{4.9} leads to very good magnetic properties when sintered with small amounts of CaF₂, properties which are maintained at elevated temperatures as depicted in FIG. 8. The best-achieved magnetic properties at room temperature with 2.5 wt % CaF₂ are: Bᵣ=10.8 kG, H_{ci}>25 kOe, (BH)ₘₐₓ=27.1 MGOe. The density of the composite specimens was 97% of the theoretical value calculated from the density of CaF₂ (3.18 g/cm³) and that of fully dense Sm(Co,Fe,Cu,Zr)_{z} magnets (8.4 g/cm³).

Structure investigation showed that CaF₂ does not dissociate during the thermal processing of the magnets. The X-ray diffraction patterns are identified and belong to the Th₂Zn₁₇ and CaF₂ structure types. However, detailed compositional analyses by EDX revealed that a small amount of Sm diffuses into the CaF₂, effectively reducing the ratio z in the Sm(Co,Fe,Cu,Zr)_{z} matrix and therefore extra amount of Sm was introduced with the Sm-rich powder. The resistivity of the composite Sm(Co,Fe,Cu,Zr)_{z}/CaF₂ magnets was found to increase up to 150% more than that of the regular Sm(Co,Fe,Cu,Zr)_{z} magnets.

A much more dramatic increase of electrical resistivity was obtained for composite magnets synthesized from blends of Sm(Co,Fe,Cu,Zr)_{z} powders with already developed hard magnetic properties and B₂O₃ powder. The electrical resistivity for samples with 2.5 wt % of B₂O₃ exceeded 1000 μΩ·cm, which is almost 12 times higher compared to the conventional sintered counterparts. The larger the (BH)ₘₐₓ of the precursor magnets, the more sensitive the powder is to milling with respect to preserving the hard magnetic properties. Only high-coercivity high-temperature Sm(Co,Fe,Cu,Zr)_{z} bulk magnet specimens were able to preserve a high coercivity upon milling to 10 μm powder. Smaller particle size that may ensure a better packing factor and higher density of the composite compacts, could retain neither magnetization (due to the lattice distortions and increased surface to volume ratio and surface oxidation) nor intrinsic coercivity (due to the defects introduced into the cellular microstructure).

What is claimed is:

1. A rare earth-transition metal-boron (RE-TM-B) permanent magnet having the formula:
RE_{11.7+x}TM_{88.3-x-y}B_{y}
where RE is selected from the group consisting of rare earth elements, Nd, Pr, Dy, and Tb;
where TM is selected from the group consisting of transition metal elements Fe, Co, Cu, Ga, and Al; and
where x is 0 to 5 and y is 5 to 7;
further comprising one or more homogeneously blended dielectric resistivity-increasing agents materials in the magnet composition, wherein the resistivity-increasing agent is selected from the group consisting of Ca(F,O)ₓ; (RE,Ca)Fₓ; (RE,Ca)(F,O)ₓ; REFₓ, RE(F,O)ₓ and mixtures thereof, where x is 0 to 5, and RE is selected from the group consisting of the rare earth elements, Nd, Pr, Dy, and Tb.

2. The magnet of claim 1, wherein the magnet comprises a homogeneous blend of Pr_{14.5}Fe_{79.5}B₆ and CaF₂ and/or NdF₃ and/or DyF₃ powders.

3. The magnet of claim 1, wherein the magnet comprises a homogeneous blend of Nd_{14.5}Fe_{79.5}B₆ and 5 wt. % DyF₃.

4. The magnet of claim 1, wherein the magnet comprises a homogeneous blend of Pr_{14.5}Fe_{79.5}B₆ and 5 wt. % DyF₃.

5. The magnet of claim 1, wherein the magnet comprises a homogeneous blend of Pr_{14.5}Fe_{79.5}B₆ and 5 wt % of CaF₂.

6. The magnet of claim 1, wherein the magnet comprises a homogeneous blend of Sm(Co_{0.70}Fe_{0.21}Cu_{0.06}Zr_{0.03})_{7.4} with Sm(Co_{0.66}Fe_{0.24}Cu_{0.07}Zr_{0.03})_{4.9} and CaF₂ powders.

7. The magnet of claim 1, wherein the magnet comprises a homogeneous blend of Sm(Co_{0.66}Fe_{0.27}Cu_{0.05}Zr_{0.02})_{7.7}+16 wt % Sm(Co_{0.62}Fe_{0.30}Cu_{0.06}Zr_{0.02})_{4.9} and CaF₂.

8. The magnet of Claim Y, wherein the magnet comprises a homogeneous blend of Sm(Co, Fe, Cu, Zr)_{z} and 2.5 wt % B₂O₃.

9. A high electrical resistivity rare earth magnet, RE—Fe—B comprising a blend of RE_{11.7+x}TM_{88.3-x-y}B_{y}, where RE is selected from the group consisting of rare earth elements Nd, Pr, Dy, and Tb, and TM is selected from the group consisting of transition metal elements, Fe, Co, Cu, Ga, and Al, with powder selected from the group of fluorides and oxyfluorides consisting of Ca(F,O)ₓ; (RE,Ca)Fₓ; (RE,Ca)(F,O)ₓ; REFₓ, RE(F,O)ₓ and mixtures thereof; where RE is selected from the group consisting of rare earth elements and mixtures thereof, and said composite rare earth magnet has an intrinsic coercivity H_{ci} at least comparable to conventional RE—Fe—B magnets, where x is 0 to 5, and y is 5 to 7.

10. Fully dense composite magnet made of blends of Sm(Co,Fe,Cu,Zr)_{z} powders and powders selected from the group consisting of fluorides and oxyfluorides having improved electrical resistivity of at least 50% higher than conventional Sm(CoFe,Cu,Zr)_{z} magnets; where the powdered fluorides and oxyfluorides are selected from the group consisting of Ca(F,O)ₓ; (RE,Ca)Fₓ; (RE,Ca)(F,O)ₓ; REFₓ, RE(F,O)ₓ and mixtures thereof, where RE is selected from the group consisting of rare earth elements and mixtures thereof, where z is 6 to 8.5 and x is 0 to 5.

11. A method for increasing the electrical resistivity and intrinsic coercivity of rare earth magnets, comprising sintering and hot pressing precursor blends of RE_{11.7+x}TM_{88.3-x-y}B_{y}, where RE is selected from the group consisting of rare earth elements, Nd, Pr, Dy, and Tb, and TM is selected from the group consisting of transition metal elements Fe, Co, Cu, Ga, and Al, with powders selected from the group of fluorides and oxyfluorides consisting of Ca(F,O)ₓ; (RE,Ca)Fₓ; (RE,Ca)(F,O)ₓ; REFₓ, RE(F,O)ₓ and mixtures thereof, where x is 0 to 5 and y is 5 to 7.

12. A method for improving the electrical resistivity of rare earth magnets comprising hot pressing and die upsetting blends of RE_{11.7+x}TM_{88.3-x-y}B_{y} powders/ribbons prepared by mechanical alloying and melt-spinning, where RE is selected from the group consisting of rare earth elements, Nd, Pr, Dy, and Tb, and TM is selected from the group consisting of transition metal elements, Fe, Co, Cu, Ga, and Al, and powders selected from the group of fluorides and oxyfluorides consisting of Ca(F,O)ₓ; (RE,Ca)Fₓ; (RE,Ca)(F,O)ₓ; REFₓ, RE(F,O)ₓ, B₂O₃ and mixtures thereof; where RE is selected from the group consisting of rare earth element and mixtures thereof, where the magnets comprise layered morphology, where x is 0 to 5 and y is 5 to 7.

13. A method for increasing the electrical resistivity of rare earth magnets, comprising sintering and heat treating precursor blends of powdered Sm(CoᵤFeᵥCu_{w}Zrₕ)_{z} where u is 0.5 to 0.8, v is 0.1 to 0.35, w is 0.03 to 0.10, h is 0.01 to 0.05, z is 6 to 8.5, and powders selected from the group of fluorides and/or oxyfluorides consisting of Ca(F,O)ₓ; (RE,Ca)Fₓ; (RE,Ca)(F,O)ₓ; REFₓ, RE(F,O)ₓ and mixtures thereof; RE is selected from the group consisting of rare earth elements and mixtures thereof, and where x is 0 to 5.

14. A method for increasing the electrical resistivity of rare earth magnets, comprising hot-pressing precursor blends of B₂O₃ powder and Sm(CoᵤFeᵥCu_{w}Zrₕ)_{z} powders where u is 0.5 to 0.8, v is 0.1 to 0.35, w is 0.03 to 0.10, h is 0.01 to 0.05, z is 6 to 8.5, or RE_{11.7+x}TM_{88.3-x-y}B_{y} powders/ribbons, where x is 0 to 5, y is 5 to 7, and RE is selected from the group consisting of rare earth elements Nd, Pr, Dy, and Tb and TM is selected from the group consisting of transition metal elements Fe, Co, Cu, Ga, and Al.
